(19) United States
(12) Patent Application Publication
(10) Pub. No.: US 2017/0104246 A1
(43) Pub. Date: Apr. 13, 2017

(54) NONAQUEOUS ELECTROLYTE SECONDARY BATTERY

(71) Applicant: TOYOTA JIDOSHA KABUSHIKI KAISHA, Toyota-shi (JP)

(72) Inventor: Kazuhisa TAKEDA, Toyota-shi (JP)

(73) Assignee: TOYOTA JIDOSHA KABUSHIKI KAISHA, Toyota-shi (JP)

(21) Appl. No.: 15/291,234

(22) Filed: Oct. 12, 2016

(30) Foreign Application Priority Data
Oct. 13, 2015 (JP) 2015-202342

(51) Int. Cl. H01M 10/42; H01M 10/0587; H01M 2/16; H01M 10/0525

(52) U.S. Cl. CPC H01M 10/4235; H01M 10/0525; H01M 10/0587; H01M 2/1646

(57) ABSTRACT

Provided is a nonaqueous electrolyte secondary battery with a high resistance to metallic lithium deposition during repeated charging and discharging. The nonaqueous electrolyte secondary battery disclosed herein includes: an electrode body including a positive electrode provided with a positive electrode active material layer, a negative electrode, and a separator interposed between the positive electrode and the negative electrode, a nonaqueous electrolyte, and a case in which the electrode body and the nonaqueous electrolyte are housed. The separator includes a heat-resistant layer. The heat-resistant layer includes an inorganic phosphate which is an acid scavenger. The heat-resistant layer faces the positive electrode active material layer.

### BACKGROUND OF THE INVENTION

1. Field of the Invention

The present teaching relates to a nonaqueous electrolyte secondary battery. The present application claims priority to Japanese Patent Application No. 2015-202342 filed on Oct. 13, 2015, the entire contents of which are incorporated by reference in the present description.

2. Description of the Related Art

Nonaqueous electrolyte secondary batteries such as lithium ion secondary batteries (lithium secondary batteries) are lighter in weight and higher in energy density than the conventional batteries. For this reason, in recent years, nonaqueous electrolyte secondary batteries have been used as the so-called portable power sources for personal computers or portable terminals and also as drive power sources for vehicles. In particular, lightweight lithium ion secondary batteries with a high energy density are expected to become increasingly popular in the future as high-output drive power sources for vehicles such as electric vehicles (EVs), hybrid vehicles (HVs), and plugin hybrid vehicles (PHVs).

It is known that where a positive electrode potential in a nonaqueous electrolyte secondary battery exceeds a predetermined value, a positive electrode active material and a nonaqueous electrolyte react with each other and the nonaqueous electrolyte is decomposed, thereby generating an acid. Compounds including a transition metal, such as transition metal oxides and lithium-transition metal phosphates, are used as the positive electrode active material, and it is known that the transition metal is eluted by the acid from the positive electrode active material and adversely affects the battery characteristics. For example, the eluted transition metal is deposited on a negative electrode and blocks the active surface of the negative electrode. Since metallic lithium tends to deposit on the blocked portions of the active surface of the negative electrode, resistance to metallic lithium deposition during repeated charging and discharging of the nonaqueous electrolyte secondary battery decreases. Accordingly, a variety of measures against the acid generated by the decomposition of the nonaqueous electrolyte have been studied.

For example, Japanese Patent Application Publication No. 2014-103098 suggests including an inorganic phosphate in a positive electrode active material layer in a nonaqueous electrolyte secondary battery provided with a positive electrode including the positive electrode active material layer, a negative electrode, and a nonaqueous electrolytic solution. Japanese Patent Application Publication No. 2014-103098 indicates that the inorganic phosphate functions as an acid-consuming material that consumes an acid present in the electrolytic solution by reacting with the acid present in the electrolytic solution, and that the elution of the transition metal from the positive electrode active material can thus be prevented.

### SUMMARY OF THE INVENTION

The comprehensive research conducted by the inventors has revealed that an electric potential unevenness occurs in a positive electrode active material layer, the electric potential becomes the highest on the surface of the positive electrode active material layer, and the decomposition of a nonaqueous electrolyte is most likely to occur on the surface of the positive electrode active material layer. It has been found that for this reason, where an inorganic phosphate is included (dispersed) in the positive electrode active material layer, as disclosed in Japanese Patent Application Publication No. 2014-103098, the acid generated by the decomposition of the nonaqueous electrolyte cannot be effectively captured by the inorganic phosphate. Therefore, in the related art, there is still room for improvement in resistance to metallic lithium deposition during repeated charging and discharging of nonaqueous electrolyte secondary batteries.

Accordingly, it is an objective of the present teaching to provide a nonaqueous electrolyte secondary battery with a high resistance to metallic lithium deposition during repeated charging and discharging.

The nonaqueous electrolyte secondary battery disclosed herein includes an electrode body including a positive electrode provided with a positive electrode active material layer, a negative electrode, and a separator interposed between the positive electrode and the negative electrode, a nonaqueous electrolyte, and a case in which the electrode body and the nonaqueous electrolyte are housed. The separator has a heat-resistant layer. The heat-resistant layer includes an inorganic phosphate which is an acid scavenger. The heat-resistant layer faces the positive electrode active material layer.

As mentioned hereinabove, the electric potential is the highest on the surface of the positive electrode active material layer, and the decomposition of the nonaqueous electrolyte is most likely to occur on the surface of the positive electrode active material layer. Thus, an acid is most likely to be generated on the surface of the positive electrode active material layer. Therefore, where the above-described configuration is used, since the heat-resistant layer of the separator that includes the inorganic phosphate, which is an acid scavenger, faces the surface of the positive electrode active material layer, the inorganic phosphate can be selectively disposed close to the surface of the positive electrode active material layer where the acid is most likely to be generated. For this reason, the generated acid can be captured by the inorganic phosphate more effectively than in the related art in which an inorganic phosphate is included in the interior of the positive electrode active material layer. As a result, the resistance to metallic lithium deposition during repeated charging and discharging of a nonaqueous electrolyte secondary battery can be increased. Therefore, with the above-described configuration, it is possible to provide a nonaqueous electrolyte secondary battery with a high resistance to metallic lithium deposition during repeated charging and discharging.

In the desired embodiment of the nonaqueous electrolyte secondary battery disclosed herein, the inorganic phosphate is lithium phosphate.

With such a configuration, since lithium phosphate has a particularly high acid scavenging capacity, it is possible to provide a nonaqueous electrolyte secondary battery with a higher resistance to metallic lithium deposition during repeated charging and discharging.

### BRIEF DESCRIPTION OF THE DRAWINGS

FIG. 1 is a cross-sectional view schematically illustrating the internal structure of a lithium ion secondary battery according to an embodiment of the present teaching;

FIG. 2 is a schematic diagram illustrating the configuration of the wound electrode body of the lithium ion secondary battery according to the embodiment of the present teaching; and

FIG. 3 is a schematic diagram illustrating part of the laminated structure of the wound electrode body of the lithium ion secondary battery according to the embodiment of the present teaching.

### DESCRIPTION OF THE PREFERRED EMBODIMENTS

An embodiment of the present teaching will be explained hereinbelow with reference to the drawings. Features other than those specifically described in the present specification, but a necessary for implementing the present teaching (for example, the typical configuration and manufacturing process of a nonaqueous electrolyte secondary battery, which do not characterize the present teaching) can be considered as design matters for a person skilled in the art. The present teaching can be implemented on the basis of the contents disclosed in the present specification and common technical knowledge in the pertinent field. In the below-described drawings, members and parts performing the same action are assigned with same reference numerals. Further, dimensional relationships (length, width, thickness, and the like) in the drawings do not necessarily reflect the actual dimensional relationships.

The “secondary battery”, as referred to in the present specification, is a general term representing power storage devices that can be repeatedly charged and discharged. This term is inclusive of the so-called storage batteries such as lithium ion secondary batteries and also power storage elements such as electric double-layer capacitors.

The present teaching will be explained hereinbelow in greater detail with reference to a flat angular lithium ion secondary battery as an exemplary embodiment, but the present teaching is not intended to be limited to the battery described in the embodiment.

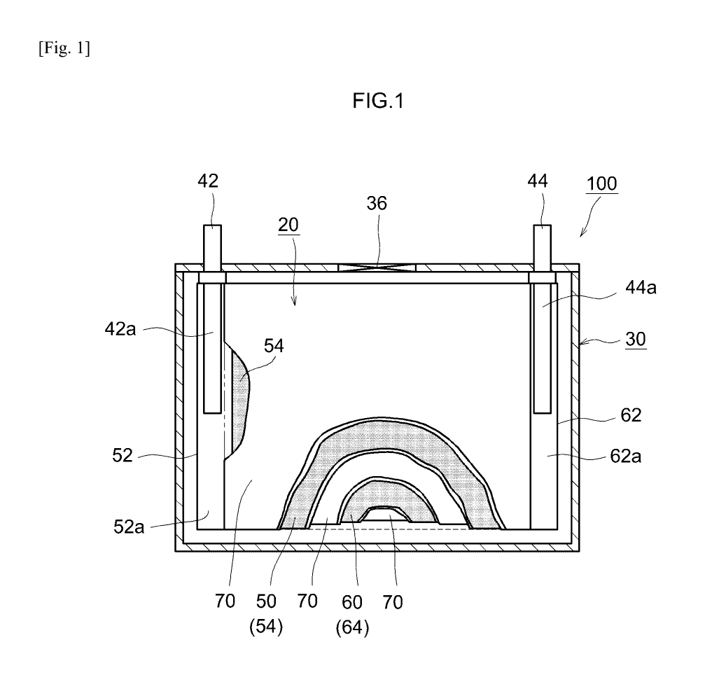

A lithium ion secondary battery 100 depicted in FIG. 1 is a sealed lithium ion secondary battery 100 configured by housing a flat wound electrode body 20 and a nonaqueous electrolyte (not depicted in the figure) in a flat angular battery case (that is, an outer case) 30. The battery case 30 is provided with a positive electrode terminal 42 and a negative electrode terminal 44 for external connection and a thin safety valve 36 that is set such as to release the internal pressure of the battery case 30 when the internal pressure rises to or above a predetermined level. The battery case 30 is also provided with a pouring hole (not depicted in the figure) for pouring the nonaqueous electrolyte. The positive electrode terminal 42 is electrically connected to a positive electrode collector plate 42a. The negative electrode terminal 44 is electrically connected to a negative electrode collector plate 44a. For example, a lightweight metal material with good thermal conductivity, such as aluminum, can be used as a material for the battery case 30.

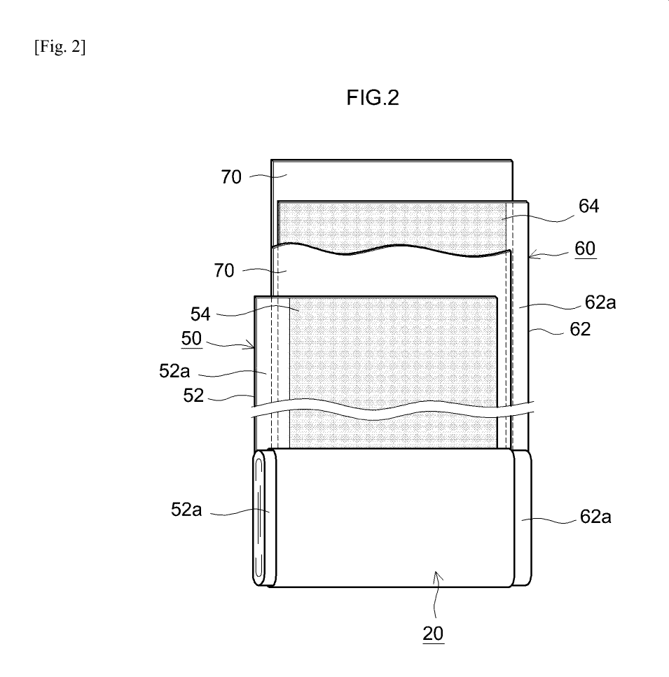

As depicted in FIGS. 1 and 2, the wound electrode body 20 has a shape in which a positive electrode sheet 50 in which a positive electrode active material layer 54 is formed along the longitudinal direction on one or both surfaces (in this case, on both surfaces) of an elongated positive electrode collector 52 and a negative electrode sheet 60 in which a negative electrode active material layer 64 is formed along the longitudinal direction on one or both surfaces (in this case, on both surfaces) of an elongated negative electrode collector 62 are laminated, with two elongated separator sheets 70 being interposed therebetween, and wound in the longitudinal direction. The positive electrode collector plate 42a and the negative electrode collector plate 44a are respectively connected to a positive electrode active material layer non-formation portion 52a (that is, a portion where the positive electrode active material layer 54 is not formed and the positive electrode collector 52 is exposed) and a negative electrode active material layer non-formation portion 62a (that is, a portion where the negative electrode active material layer 64 is not formed and the negative electrode collector 62 is exposed) which are formed to protrude outward from two ends of the wound electrode body 20 in the winding axis direction (that is, in the width direction of the sheet which is perpendicular to the longitudinal direction).

Positive electrode sheets and negative electrode sheets such as have been used in the conventional lithium ion secondary batteries can be used, without any particular restriction, as the positive electrode sheet 50 and the negative electrode sheet 60. Typical embodiments thereof are described below.

For example, an aluminum foil can be used as the positive electrode collector 52 constituting the positive electrode sheet 50. Examples of the positive electrode active material contained in the positive electrode active material layer 54 include lithium transition metal oxides (for example, LiNi_{1/3}Co_{1/3}Mn_{1/3}O₂, LiNiO₂, LiCoO₂, LiFeO₂, LiMn₂O₄, and LiNi_{0.5}Mn_{1.5}O₄) and lithium transition metal phosphates (for example, LiFePO₄). The positive electrode active material layer 54 can also include components other than the active material, for example, an electrically conductive material and a binder. For example, carbon black such as acetylene black (AB) and other carbon materials (for example, graphite) can be advantageously used as the electrically conductive material. For example, polyvinylidene fluoride (PVDF) can be used as the binder.

The positive electrode active material is typically in a particulate form. The average particle diameter of the particulate positive electrode active material is not particularly limited and is usually 20 μm or less (typically 1 μm to 20 μm, for example, 5 μm to 15 μm). The “average particle diameter”, as referred to in the present specification, is a particle diameter (median diameter) corresponding to cumulative 50% from the fine particle side in a particle size distribution measured by a general laser diffraction/light scattering method. The BET specific surface area of the positive electrode active material is not particularly limited and is usually 0.1 m²/g or more (typically 0.7 m²/g or more, for example, 0.8 m²/g or more) and usually 5 m²/g or less (typically 1.3 m²/g or less, for example, 1.2 m²/g or less).

The average thickness per one side of the positive electrode active material layer 54 is not particularly limited and is, for example, 20 μm or more (typically 40 μm or more, desirably 50 μm or more), and 100 μm or less (typically 80 μm or less). The density of the positive electrode active material layer 54 is not particularly limited and is, for example, 1 g/cm³ or more (typically 1.5 g/cm³ or more) and, for example, 4 g/cm³ or less (typically 3.5 g/cm³ or less).

For example, a copper foil can be used as the negative electrode collector 62 constituting the negative electrode sheet 60. For example, a carbon material such as graphite, hard carbon, and soft carbon can be used as the negative electrode active material contained in the negative electrode active material layer 64. The negative electrode active material layer 64 can include components other than the active material, for example, a binder and a thickening agent. For example, a styrene-butadiene rubber (SBR) can be used as the binder. For example, carboxymethyl cellulose (CMC) can be used as the thickening agent.

The negative electrode active material is typically in a particulate form. The average particle diameter of the particulate negative electrode active material is not particularly limited and is usually 50 μm or less (typically 20 μm or less, for example, 1 μm to 20 μm, and desirably, 5 μm to 15 μm). The BET specific surface area of the negative electrode active material is not particularly limited and is usually 1 m²/g or more (typically 2.5 m²/g or more, for example, 2.8 m²/g or more) and usually 10 m²/g or less (typically 3.5 m²/g or less, for example, 3.4 m²/g or less).

The average thickness per one side of the negative electrode active material layer 64 is not particularly limited and is usually 40 μm or more (typically 50 μm or more), and usually 100 μm or less (typically 80 μm or less). The density of the negative electrode active material layer 64 is not particularly limited and is usually 0.5 g/cm³ or more (typically 1 g/cm³ or more) and usually 2 g/cm³ or less (typically 1.5 g/cm³ or less).

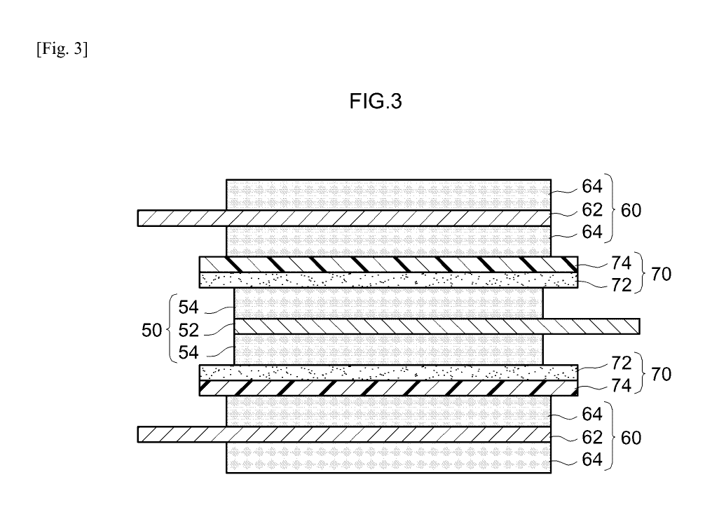

In the present embodiment, as depicted in FIG. 3, a separator including a heat-resistant layer (HRL) 72 is used as the separator 70. In FIG. 3, the separator 70 has the heat-resistant layer 72 and a base material layer (in this case, a porous resin sheet layer 74). The heat-resistant layer 72 is disposed to face the positive electrode active material layer 54 of the positive electrode 50. In the present embodiment, the heat-resistant layer 72 is in contact with the positive electrode active material layer 54 of the positive electrode 50. The heat-resistant layer 72 includes an inorganic phosphate which is an acid scavenger.

In the related art, an inorganic phosphate which is an acid scavenger has been contained in the positive electrode active material layer, as in the technique disclosed in Japanese Patent Application Publication No. 2014-103098. Where an inorganic phosphate is contained in the positive electrode active material layer, as in the related art (the technique disclosed in Japanese Patent Application Publication No. 2014-103098), the inorganic phosphate is present inside the positive electrode active material layer in a dispersed state.

By contrast, the comprehensive research conducted by the inventors has revealed that an electric potential unevenness occurs in a positive electrode active material layer, the electric potential becomes the highest on the surface of the positive electrode active material layer, and the decomposition of a nonaqueous electrolyte is most likely to occur on the surface of the positive electrode active material layer. Thus, it has been found that an acid is most likely to be generated on the surface of the positive electrode active material layer. Therefore, where an inorganic phosphate is contained in the positive electrode active material layer, as described in Japanese Patent Application Publication No. 2014-103098, the inorganic phosphate present in the surface portion of the positive electrode active material layer can capture the acid generated by the decomposition of the nonaqueous electrolyte, but the inorganic oxide present not in the surface portion of the positive electrode active material layer practically cannot capture the acid. Specifically, in the related art, the acid cannot be effectively captured by the inorganic phosphate, and there is still room for improvement in resistance to metallic lithium deposition during repeated charging and discharging of nonaqueous electrolyte secondary batteries.

In the related art, by increasing the content of the inorganic phosphate in the positive electrode active material layer, it is possible to increase the amount of the inorganic phosphate present in the surface portion of the positive electrode active material layer, but introducing an excessive amount of inorganic phosphate in the positive electrode active material layer is not practical because it increases the electric resistance of the positive electrode (positive electrode active material layer).

Accordingly, in the present embodiment, an inorganic phosphate, which is an acid scavenger, is introduced in the heat-resistant layer 72 of the separator 70. In addition, the heat-resistant layer 72 of the separator 70 faces the positive electrode active material layer 54. As a result, the inorganic phosphate can be selectively disposed close to the surface of the positive electrode active material layer 54 where an acid is most likely to be generated. As a result, the generated acid can be captured by the inorganic phosphate more effectively than in the related art in which the inorganic phosphate is contained inside the positive electrode active material layer, and the resistance to metallic lithium deposition during repeated charging and discharging can be increased. Furthermore, since the inorganic phosphate is present in the heat-resistant layer 72, even when the amount of the inorganic phosphate is large, the electric resistance of the positive electrode (in particular, the positive electrode active material layer) is not increased. The resulting effects are that the amount of the inorganic phosphate, which is an acid scavenger, can be also increased and the amount of the captured acid can be increased.

Examples of inorganic phosphates functioning as acid scavengers include alkali metal salts or group 2 element salts of phosphoric acid and pyrophosphoric acid. These salts consume the acid present in the nonaqueous electrolyte by capturing the acid present in the nonaqueous electrolyte and reacting with the acid. Examples of the alkali metals include lithium, sodium, and potassium. Examples of the group 2 elements include magnesium, calcium, strontium, and barium. Among them, salts of phosphoric acid and at least one metal selected from the group consisting of lithium, sodium, potassium, magnesium, and calcium are desired because of a high acid scavenging capacity, and lithium phosphate (Li₃PO₄) is more desired.

The heat-resistant layer 72 can include materials that are usually used in heat-resistant layers for separators of lithium ion secondary batteries. More specifically, the heat-resistant layer includes an inorganic filler and optionally can include a binder and a thickening agent.

Examples of the inorganic filler include inorganic oxides such as alumina (Al₂O₃), magnesia (MgO), silica (SiO₂), and titania (TiO₂), nitrides such as aluminum nitride and silicon nitride, metal hydroxides such as calcium hydroxide, magnesium hydroxide, and aluminum hydroxide, clay minerals such as mica, talc, boehmite, zeolites, apatite, and kaolin, and glass fibers. Among them, it is desired that alumina, boehmite, and magnesia be used. These inorganic fillers have a high melting point and excel in heat resistance. Further, they have a comparatively high Mohs hardness and excel in mechanical strength and durability. Furthermore, since they are comparatively inexpensive, the cost of starting materials can be reduced.

The shape of the inorganic filler is not particularly limited, and the filler may be in a particulate, fiber, or plate (flake) shape. From the standpoint of dispersion stability, and the like, it is desired that the average particle diameter of the inorganic filler be 5 μm or less, more desirably 2 μm or less, and even more desirably 1 μm or less. The lower limit value is not particularly limited, but from the standpoint of handleability, the lower limit value is desirably 0.01 μm or more, more desirably 0.1 μm or more, and even more desirably 0.2 μm or more. The BET specific surface area is usually 1 m²/g to 100 m²/g (for example, 1.5 m²/g to 50 m²/g, typically 2 m²/g to 10 m²/g).

Examples of binders for the heat-resistant layer 72 include acrylic binders, styrene-butadiene rubber (SBR), and polyolefin binders. Fluoropolymers such as polyvinylidene fluoride (PVDF) and polytetrafluoroethylene (PTFE) can be also used.

Examples of thickening agents for the heat-resistant layer 72 include carboxymethyl cellulose (CMC) and methyl cellulose (MC).

The amount of the inorganic filler in the heat-resistant layer 72 is, for example, 50% by mass or more, desirably 70% by mass to 87% by mass. The amount of the inorganic phosphate in the heat-resistant layer 72 is, for example, 5% by mass to 30% by mass, desirably more than 100/by mass to 20% by mass, and more desirably 11% by mass to 15% by mass. The amount of the binder in the heat-resistant layer 72 is, for example, 1% by mass to 10% by mass, and desirably 1% by mass to 5% by mass. The amount of the thickening agent in the heat-resistant layer 72 is, for example, 1% by mass to 10% by mass, and desirably 1% by mass to 5% by mass.

The thickness of the heat-resistant layer 72 is not particularly limited and is usually 0.5 μm or more, typically 1 μm or more, desirably 2 μm or more, and more desirably 5 μm or more. Meanwhile, the thickness of the heat-resistant layer 72 is usually 20 μm or less, typically 15 μm or less, and desirably 10 μm or less.

Examples of the resin constituting the porous resin sheet layer 74 include polyethylene (PE), polypropylene (PP), polyesters, cellulose, and polyamides. The porous resin sheet layer 74 may have a monolayer structure or a laminated structure of two or more layers (for example, a three-layer structure in which a PP layer is laminated on both surfaces of a PE layer).

The thickness of the porous resin sheet layer 74 is usually 10 μm or more, typically 15 μm or more, for example, 17 μm or more. Meanwhile, the thickness of the porous resin sheet layer 74 is usually 40 μm or less, typically 30 μm or less, for example, 25 μm or less.

A separate heat-resistant layer may be provided on the surface of the porous resin sheet layer 74 facing the negative electrode. The separate heat-resistant layer may or may not include an inorganic phosphate which is an acid scavenger. The separate heat-resistant layer may be configured similarly to the typical heat-resistant layer of the separators of lithium ion secondary batteries.

A nonaqueous electrolyte which is the same as or similar to that of the conventional lithium ion secondary batteries can be used. Typically, a nonaqueous electrolyte in which a support salt is contained in an organic solvent (nonaqueous solvent) can be used. Organic solvents such as various carbonates, ethers, esters, nitriles, sulfones, and lactones which are used in electrolytic solutions of typical lithium ion secondary batteries can be used, without any particular limitation, as the nonaqueous solvent. Specific examples thereof include ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyldifluoromethyl carbonate (F-DMC), and trifluorodimethyl carbonate (TFDMC). Such nonaqueous solvents can be used individually or as appropriate combinations of two or more thereof. For example, lithium salts such as LiPF₆, LiBF₄, and LiCIO₄ (desirably, LiPF₆) can be advantageously used as the support salt. The concentration of the support salt is desirably 0.7 mol/L to 1.3 mol/L.

Provided that the advantageous effects of the present teaching are not significantly degraded, the nonaqueous electrolyte can include various additives such as a gas generating agent such as biphenyl (BP) and cyclohexylbenzene (CHB); a film-forming agent such as an oxalate complex compound including a boron atom and/or a phosphorus atom, and vinyl carbonate (VC); a dispersant; and a thickening agent.

The lithium ion secondary battery 100 configured in the above-described manner can be used in a variety of applications. The suitable applications include drive power sources installed on vehicles such as electric vehicles (EVs), hybrid vehicles (HVs), and plugin hybrid vehicles (PHVs). The lithium ion secondary batteries 100 are typically used in the form of battery packs in which a plurality of batteries are connected in series and/or in parallel.

Explained hereinabove by way of example is the angular lithium ion secondary battery 100 provided with the flat wound electrode body 20. However, the lithium ion secondary battery can be also configured to have a laminated electrode body or as a cylindrical lithium ion secondary battery. Further, the technique disclosed herein is also applicable to nonaqueous electrolyte secondary batteries other than the lithium ion secondary battery.

Examples relating to the present teaching will be described hereinbelow, but the present teaching is not intended to be limited to these examples.

<Fabrication of Separator A>

Boehmite, an acrylic binder, and CMC were weighed to obtain a mass ratio thereof of 95:2.5:2.5. These materials were dispersed in water to obtain a paste-like composition for forming a heat-resistant layer. The composition for forming a heat-resistant layer was coated at a coating amount of 0.75 mg/cm² and dried on one surface of a porous polyolefin sheet (average thickness 20 μm) in which PP was laminated on both surfaces of PE. A separator A provided with the porous polyolefin layer and the heat-resistant layer was thus fabricated.

<Fabrication of Separator B>

Boehmite, Li₃PO₄, an acrylic binder, and CMC were weighed to obtain a mass ratio thereof of 81.9:13.8:2.2:2.2. These materials were dispersed in water to obtain a paste-like composition for forming a heat-resistant layer. The composition for forming a heat-resistant layer was coated at a coating amount of 0.87 mg/cm² and dried on one surface of a porous polyolefin sheet (average thickness 20 μm) in which PP was laminated on both surfaces of PE. A separator B provided with the porous polyolefin layer and the heat-resistant layer was thus fabricated. The coating amount of Li₃PO₄ in the separator B was 0.12 mg/cm².

<Fabrication of Battery No. 1>

LiNi₁₃Co₁₁/3Mn₁₁/30O₂ (LNCM) as a positive electrode active material powder, AB as an electrically conductive material, and PVDF as a binder were mixed at a mass ratio of LNCM:AB:PVDF=90:8:2 with N-methyl pyrrolidone (NMP) to prepare a slurry for forming a positive electrode active material layer. The slurry was band-like coated on both surfaces of an elongated aluminum foil (positive electrode collector) (coating amount: 6 mg/cm² per one side) and dried to fabricate a positive electrode.

Further, graphite (C) as a negative electrode active material, SBR as a binder, and CMC as a thickening agent were mixed at a mass ratio of C:SBR:CMC=98:1:1 with ion-exchanged water to prepare a slurry for forming a negative electrode active material layer. The slurry was band-like coated on both surfaces of an elongated copper foil (negative electrode collector), dried, and then pressed to fabricate a negative electrode.

The fabricated positive electrode and negative electrode and also two separators A were laminated and wound to fabricate a wound electrode body. In this case, the separators A were interposed between the positive electrode and the negative electrode, and the heat-resistant layer of the separator A faced the positive electrode (positive electrode active material layer).

The fabricated wound electrode body was housed in a battery case. A nonaqueous electrolyte was then poured in from the opening of the battery case and the opening was air-tightly sealed to fabricate a lithium ion secondary battery assembly. The nonaqueous electrolyte was prepared by dissolving LiPF₆ as a support salt at a concentration of 1.1 mol/L in a mixed solvent including ethylene carbonate (EC), ethyl methyl carbonate (EMC), and dimethyl carbonate (DMC) at a volume ratio of EC:EMC:DMC=3:3:4. A lithium ion secondary battery No. 1 was obtained by initially charging the obtained lithium ion secondary battery assembly.

<Fabrication of battery No. 2>

LiNi_{1/3}Co_{1/3}Mn_{1/3}O₂ (LNCM) as a positive electrode active material powder, AB as an electrically conductive material, PVDF as a binder, and Li₃PO₄ as an acid scavenger were mixed at a mass ratio of LNCM:AB:PVDF:Li₃PO₄=90:8:2:2 with N-methyl pyrrolidone (NMP) to prepare a slurry for forming a positive electrode active material layer. The slurry was band-like coated on both surfaces of an elongated aluminum foil (positive electrode collector) (coating amount: 6.12 mg/cm² per one side) and dried to fabricate a positive electrode.

A negative electrode was then fabricated in the same manner as in the fabrication example of the lithium ion secondary battery No. 1.

The fabricated positive electrode and negative electrode and also two separators A were laminated and wound to fabricate a wound electrode body. In this case, the separators A were interposed between the positive electrode and the negative electrode, and the heat-resistant layer of the separator A faced the positive electrode (positive electrode active material layer).

A lithium ion secondary battery assembly was fabricated in the same manner as in the fabrication example of the lithium ion secondary battery No. 1 by using the fabricated wound electrode body. A lithium ion secondary battery No. 2 was obtained by initially charging the obtained lithium ion secondary battery assembly.

<Fabrication of battery No. 3>

A positive electrode and a negative electrode were fabricated in the same manner as in the fabrication example of the lithium ion secondary battery No. 1.

The fabricated positive electrode and negative electrode and also two separators B were laminated and wound to fabricate a wound electrode body. In this case, the separators B were interposed between the positive electrode and the negative electrode, and the heat-resistant layer of the separator B faced the negative electrode (negative electrode active material layer).

A lithium ion secondary battery assembly was fabricated in the same manner as in the fabrication example of the lithium ion secondary battery No. 1 by using the fabricated wound electrode body. A lithium ion secondary battery No. 3 was obtained by initially charging the obtained lithium ion secondary battery assembly.

<Fabrication of Battery No. 4>

A positive electrode and a negative electrode were fabricated in the same manner as in the fabrication example of the lithium ion secondary battery No. 1.

The fabricated positive electrode and negative electrode and also two separators B were laminated and wound to fabricate a wound electrode body. In this case, the separators B were interposed between the positive electrode and the negative electrode, and the heat-resistant layer of the separator B faced the positive electrode (positive electrode active material layer).

A lithium ion secondary battery assembly was fabricated in the same manner as in the fabrication example of the lithium ion secondary battery No. 1 by using the fabricated wound electrode body. A lithium ion secondary battery No. 4 was obtained by initially charging the obtained lithium ion secondary battery assembly.

<Test 1 (Evaluation of Initial Limit Current Value)>

A total of 1000 charge-discharge cycles were implemented with the lithium ion secondary batteries No. 1 to No. 4 under an environment at −10° C., one cycle including charging for 5 s at a predetermined current value, allowing the battery to stand for 10 min, discharging for 5 s, and allowing the battery to stand for 10 min. The lithium ion secondary batteries were then disassembled, and the presence/absence of deposition of metallic lithium on the negative electrode was confirmed. The maximum current value within the current value range in which the deposition of metallic lithium on the negative electrode was not confirmed was taken as a limit current value. The ratio of limit current values of lithium ion secondary batteries No. 2 to No. 4 to the limit current value of the lithium ion secondary battery No. 1 as a reference was determined as a percentage (%). The results are shown in Table 1.

<Test 2 (Evaluation of Limit Current Value after Durability Test)>

The lithium ion secondary batteries No. 1 to No. 4 were deteriorated by storing for 60 days under a high-temperature environment at 75° C. Then, a total of 1000 charge-discharge cycles were implemented with the lithium ion secondary batteries No. 1 to No. 4 under an environment at −10° C., one cycle including charging for 5 s at a predetermined current value, allowing the battery to stand for 10 min, discharging for 5 s, and allowing the battery to stand for 10 min. The lithium ion secondary batteries were then disassembled, and the presence/absence of deposition of metallic lithium on the negative electrode was confirmed. The maximum current value within the current value range in which the deposition of metallic lithium on the negative electrode was not confirmed was taken as a limit current value. The ratio of limit current values of lithium ion secondary batteries No. 2 to No. 4 to the limit current value of the lithium ion secondary battery No. 1 as a reference was determined as a percentage (%). The results are shown in Table 1.

TABLE 1

| | Test 1 | Test 2 |
|---|---|---|
| | Initial limit current value | Initial limit current value |
| Battery | ratio (%) | ratio (%) after durability test |
| No. 1 | 100 | 100 |
| No. 2 | 103 | 105 |
| No. 3 | 100 | 101 |
| No. 4 | 106 | 109 |

In Table 1, a larger value of the limit current value ratio means a higher resistance to metallic lithium deposition. In the lithium ion secondary battery No. 1, which was taken as a reference, the inorganic phosphate (acid scavenger) was not added. In the lithium ion secondary battery No. 2 in which the inorganic phosphate was added to the positive electrode active material layer as in the related art, the initial limit current value ratio was 103%, the initial limit current value ratio after the durability test was 105%, and a high resistance to metallic lithium deposition was demonstrated. In the lithium ion secondary battery No. 3 in which the inorganic phosphate was added to the heat-resistant layer of the separator, but the heat-resistant layer faced the negative electrode active material layer, the limit current value was practically the same as in the lithium ion secondary battery No. 1. However, in the lithium ion secondary battery No. 4 in which the inorganic phosphate was added to the heat-resistant layer of the separator and the heat-resistant layer faced the positive electrode active material layer, the initial limit current value ratio was 106%, the limit current value ratio after the durability test was 109%, and the resistance to metallic lithium deposition was much higher than that of the lithium ion secondary battery No. 2.

The results described hereinabove indicate that the lithium ion secondary battery according to the present embodiment in which the heat-resistant layer of the separator includes the inorganic phosphate, which is an acid scavenger, and the heat-resistant layer of the separator faces the positive electrode active material layer has a high resistance to metallic lithium deposition during repeated charging and discharging.

Specific examples of the present teaching are described hereinabove in detail, but these examples are not limiting and place no restriction on the claims. The technique set forth in the claims is inclusive of various modifications and changes of the specific examples presented hereinabove.

What is claimed is:

1. A nonaqueous electrolyte secondary battery comprising:
an electrode body including a positive electrode provided with a positive electrode active material layer, a negative electrode, and a separator interposed between the positive electrode and the negative electrode;
a nonaqueous electrolyte; and
a case in which the electrode body and the nonaqueous electrolyte are housed, wherein
the separator includes a heat-resistant layer,
the heat-resistant layer includes an inorganic phosphate which is an acid scavenger, and
the heat-resistant layer faces the positive electrode active material layer.

2. The nonaqueous electrolyte secondary battery according to claim 1, wherein the inorganic phosphate is lithium phosphate.
